(19) United States
(12) Patent Application Publication
(10) Pub. No.: US 2008/0093038 A1
(43) Pub. Date: Apr. 24, 2008

(54) Roller blind arrangement

(76) Inventor: Melf Hansen, Gondelsheim (DE)

Correspondence Address: FLYNN THIEL BOUTELL & TANIS, P.C., 2026 RAMBLING ROAD, KALAMAZOO, MI, 49008-1631, US

(21) Appl. No.: 11/904,268

(22) Filed: Sep. 26, 2007

(30) Foreign Application Priority Data
Sep. 26, 2006 (DE) 102006047123.7

(51) Int. Cl. E06B 9/56

(52) U.S. Cl. 160/316

(57) ABSTRACT

A roller blind arrangement has a hollow tubular winding shaft holding a flexible sheet, and a winding spring which is placed in a spring receptacle section. A first end of the winding spring is rotationally affixed to the winding shaft. A second end is fixed to a holding section rotatable about a main axis of the winding shaft. The winding spring has an outer diameter smaller than the inner diameter of the spring receptacle section. The radial mobility of the winding spring is delimited by an inner wall of the spring receptacle section. The winding spring, in a relaxed state, is longer than the spring receptacle section such that the winding spring, in a compressed and untwisted state in which it is compressed approximately to the length of the spring receptacle section, bears substantially over its entire length against the inner wall of the spring receptacle section.

### FIELD OF APPLICATION AND PRIOR ART

The invention relates to a roller blind arrangement, in particular for use in a vehicle, having a hollow tubular winding shaft, which extends in a main direction of extent, for holding, in a rolled-up fashion, a flexible sheet which can be pulled down, and a winding spring which is placed in a spring receptacle section of the winding shaft and is embodied as a coil spring, with a first end of the winding spring being rotationally fixedly connected to the winding shaft, a second end of the winding spring being rotationally fixedly connected to a holding section which is designed so as to be rotatable relative to the winding shaft about a main axis of the winding shaft, the winding spring having an outer diameter which is smaller than the inner diameter of the spring receptacle section, and the radial mobility of the winding spring transversely with respect to the main direction of extent of the winding spring being delimited only by an inner wall of the spring receptacle section.

Roller blinds of said type are known from the prior art. In the case of said roller blinds, the length of the winding spring is dimensioned such that the winding spring has an identical or shorter length than the spring receptacle section. As a result of a shorter length and the resulting tensile state of the spring, it is obtained that the spring is held under tension in the interior of the winding shaft, and contact between the inner wall of the spring receptacle section and the winding spring in the event of slight vibrations of the spring is prevented.

DE 19902016 C1 discloses a spring roller blind in which a preload spring is inserted between an inner preload shaft and an outer roller blind shaft. Said preload spring forms, in an assembled state of the spring roller blind, a pressure spring, as a result of which it is obtained that the spring presses a preload shaft bearing journal outward.

A disadvantage of the prior art is considered that noise generation within the winding shaft, in particular as a result of vibrations, is not sufficiently well prevented.

### OBJECT AND ACHIEVEMENT OF OBJECT

It is an object of the invention to improve a roller blind arrangement of the generic type with regard to reduced noise generation.

According to the invention, the winding spring, in a relaxed state in the main direction of extent, is longer by a length difference than the spring receptacle section, with the length difference being dimensioned such that the winding spring, in a compressed and untwisted state in which the winding spring is compressed approximately to the length of the spring receptacle section, bears substantially over its entire length against the inner wall of the spring receptacle section.

The elastic compression has the result, in the case of a roller blind arrangement according to the invention, that no free vibration of the winding spring is possible even in the untwisted state. Here, the noise generation is prevented not in that the spring for example comes into contact with the winding shaft as a result of high tensile loading, but rather in that said spring always bears against the inner wall of the winding shaft regardless of the operating state. As the winding shaft rotates, the spring is twisted, with said spring remaining in contact with the winding shaft at all times. The friction moment which is generated here is normally negligible in relation to the torsion moment required for the torsion. If appropriate, it is possible by means of a corresponding material combination or lubrication to obtain a further reduction in the friction moment.

In one refinement of the invention, the holding section is designed so as to be axially moveable in the main direction of extent.

In this way, the holding section can be pressed outward at least to a limited extent by the compressed winding spring. Said outwardly acting force can be utilized to mount the roller blind arrangement without play. For this purpose, a bearing bolt is preferably provided at both ends of the winding shaft, with the first bearing bolt being designed so as to be fixed to the winding shaft and the second bearing bolt being formed on the holding section. As it is inserted, said bearing bolt is pressed in by a pressing-in force counter to the spring force of the winding spring, such that the overall length of the roller blind arrangement is shortened. In said shortened state, the roller blind arrangement is inserted with the bearing journals into corresponding journal receptacles of a bracket, such that after the pressing-in force is released and the moveable bearing bolt returns into its initial position, secure fastening of the winding shaft is obtained.

In one refinement of the invention, the axial mobility of the holding section is delimited by a stop.

The holding section is thereby suitable for holding the winding spring securely in the spring receptacle section of the winding shaft without it being possible for said winding spring to leave the spring receptacle section. Here, the stop is preferably designed so as to axially delimit the holding section only in a position in which the overall width of the winding shaft from the first to the second bearing bolt is greater than a corresponding installation width. Both secure handling of the roller blind arrangement in the non-installed state, and also play-free operation of the roller blind arrangement in the intended bracket, are therefore possible.

In one refinement of the invention, the length difference is dimensioned such that a contact line along which the winding spring bears, in the compressed state, against the inner wall of the spring receptacle section has the shape of a helix with at least one turn.

The helical shape which the winding spring assumes for this purpose prevents, even in the event of intense vibrations, that the winding spring changes its position within the spring receptacle section. Regardless of the direction in which the force generated by the vibrations acts, a section, which bears counter to said direction against the winding shaft wall, of the winding spring serves to prevent the winding spring from changing its position against the winding shaft wall as a result of its inertia. Here, the pitch direction of the contact line helix is preferably selected such that a twisting of the winding spring as the sheet is pulled down leads to a reduction in the pitch of the contact line helix and to an increase in the number of turns of the contact line. This orientation prevents that the contact line helix loses contact with the winding shaft wall as the winding spring is twisted.

In one refinement of the invention, the length difference is at least 10%, preferably at least 20%.

A length difference of 10%, preferably 20% has proven to be particularly advantageous. Said length difference results in a helical configuration of the contact line within the spring receptacle section and only increases the weight of the roller blind arrangement by a negligible amount.

In one refinement of the invention, the winding spring has an adhesion-reducing and/or noise-reducing casing.

Such a casing can be designed either such that it surrounds each turn of the winding spring individually, or as a hose casing which encases the winding spring in its entirety. The casing ensures that the friction losses as the winding spring is twisted as the sheet is pulled down are reduced. Rubber or plastic casings for example lend themselves to use as a purely noise-reducing casing. Chrome coatings on the inside of the spring receptacle section and on the winding spring can for example serve as adhesion-reducing casings.

### BRIEF DESCRIPTION OF THE DRAWINGS

Further advantages and features of the invention can be gathered from the claims and from the following description of a preferred exemplary embodiment of the invention which is illustrated on the basis of the drawings, in which:

FIG. 1 shows a roller blind arrangement according to the invention with an open spring receptacle section, and

FIG. 2 shows the roller blind arrangement of FIG. 1 with a compressed winding spring in the closed spring receptacle section.

### DETAILED DESCRIPTION OF THE EXEMPLARY EMBODIMENTS

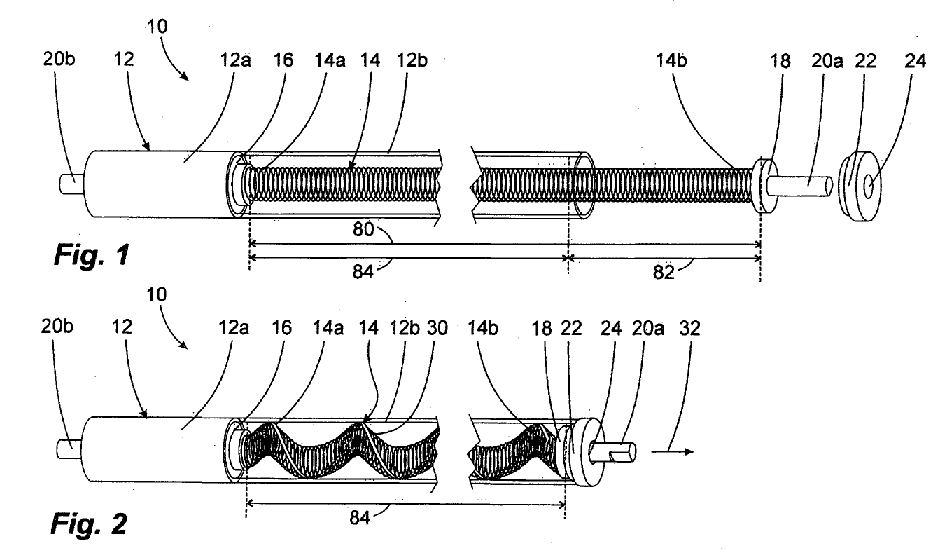

FIG. 1 shows a roller blind arrangement 10 whose essential components are a winding shaft 12 and a winding spring 14. The winding shaft 12 is embodied as a hollow tube which, in the illustrated embodiment, is illustrated partially transparently for better understanding. The winding shaft serves to hold a sheet in a rolled-up form, with said sheet not being illustrated in the figures. Provided in the winding shaft 12 is a spring receptacle 16 which is rotationally fixedly connected to the winding shaft 12 at one side and to a first end 14a of the winding spring 14. The spring receptacle 16 divides the winding shaft into a springless section 12a and a spring receptacle section 12b.

The winding spring 14 has, in the relaxed state, a length 80 which is longer by a length difference 82 than a length 84 of the spring receptacle section 12b. Provided at the second end of the winding spring 14 is a holding section 18 which is rotationally fixedly connected to the second end 14b of the winding spring 14. The holding section 18 has a base body with a cylindrical shape whose diameter is slightly smaller than the inner diameter of the spring receptacle section 12b. Provided on the holding section 18 and on the opposite side of the winding shaft 12 from the spring receptacle section 12b are bearing bolts 20a, 20b which serve for fastening the roller blind arrangement in a bracket (not illustrated). The bearing bolt 20a has a flattened portion at one side which serves the purpose of being able to connect the bearing bolt 20a to said bracket in a rotationally fixed manner.

In order to close off the bearing section, a closure 22 is provided which is dimensioned such that it forms a press fit with the inner wall of the spring receptacle section 12b. Instead of or in addition to this, it is possible for the closure and/or the spring receptacle section to be connected in a form-fitting manner, for example by means of a thread, or else in a cohesively joined manner, for example by means of an adhesive connection.

Arranged centrally in the closure is an axial aperture 24 which has a larger inner diameter than the outer diameter of the bearing bolt 20a.

FIG. 2 shows the roller blind arrangement 10 in a state in which it is ready for installation. Here, the winding spring 14 is compressed to the length 84, so that it is situated entirely in the spring receptacle section 12b of the winding shaft 12. In this state, the holding section 18 is likewise arranged within the winding shaft 12. The open end of the spring receptacle section 12b is closed off by means of the closure 22, so that a release of the holding section 18 out of the winding shaft 12 is prevented. The bearing bolt 20a projects outward through the bore 24 of the closure 22.

In the illustrated compressed state, the winding spring 14 is compressed to such an extent that it bears over almost its entire length against the inner wall of the spring receptacle section 12b. The contact line 30 which indicates the contact region between the winding spring 14 and the winding shaft 12 is of spiral-shaped form, so that the winding spring 14 no longer has any radial freedom of movement. In this state, even intense vibrations of the roller blind arrangement 10 do not lead to a relative movement of the winding spring 14 on the one hand and the spring receptacle section 12b on the other hand, or to said winding spring 14 and spring receptacle section 12b striking against one another. A disturbing generation of noise as a result of vibrations is therefore largely avoided. The compression of the winding spring 14 additionally ensures that the bolt 20a is acted on with a force which acts in the direction of the arrow 32, so that the roller blind arrangement can be mounted in a play-free manner in the inserted state.

1. Roller blind arrangement having
a hollow tubular winding shaft, which extends in a main direction of extent, for holding, in a rolled-up fashion, a flexible sheet which can be pulled down, and
a winding spring which is placed in a spring receptacle section of the winding shaft and is embodied as a coil spring, with
a first end of the winding spring being rotationally fixedly connected to the winding shaft,
a second end of the winding spring being rotationally fixedly connected to a holding section which is designed so as to be rotatable relative to the winding shaft about a main axis of the winding shaft,
the winding spring having an outer diameter which is smaller than the inner diameter of the spring receptacle section, and
the radial mobility of the winding spring transversely with respect to the main direction of extent of the winding spring being delimited only by an inner wall of the spring receptacle section, wherein
the winding spring, in a relaxed state in the main direction of extent, is longer by a length difference than the spring receptacle section, with the length difference being dimensioned such that the winding spring, in a compressed and untwisted state in which the winding spring is compressed approximately to the length of the spring receptacle section, bears substantially over its entire length against the inner wall of the spring receptacle section.

2. Roller blind arrangement according to claim 1, wherein
the holding section is designed so as to be axially moveable in the main direction of extent.

3. Roller blind arrangement according to claim 2, wherein
the axial mobility of the holding section is delimited by a stop.

4. Roller blind arrangement according to claim 1,
wherein
the length difference is dimensioned such that a contact line along which the winding spring bears, in the compressed state, against the inner wall of the spring receptacle section has the shape of a helix with at least one turn.

5. Roller blind arrangement according to claim 1,
wherein
the length difference is at least 10% of the length of the spring receptacle section.

6. Roller blind arrangement according to claim 1,
wherein
the winding spring has an adhesion-reducing casing.

7. Roller blind arrangement according to claim 5, wherein the length difference is at least 20% of the spring receptacle section.

8. Roller blind arrangement according to claim 1, wherein the winding spring has noise-reducing casing.
